(19) United States
(12) Patent Application Publication
(10) Pub. No.: US 2015/0116588 A1
(43) Pub. Date: Apr. 30, 2015

(54) IMAGE CAPTURING MODULE AND ACTUATOR STRUCTURE THEREOF

(71) Applicant: LARVIEW TECHNOLOGIES CORP., TAOYUAN COUNTY (TW)

(72) Inventor: CHARLES IAN DADUYA FERRARIS, TAOYUAN COUNTY (TW)

(73) Assignee: LARVIEW TECHNOLOGIES CORP., TAOYUAN COUNTY (TW)

(21) Appl. No.: 14/063,680

(22) Filed: Oct. 25, 2013

(51) Int. Cl. H04N 5/225

(52) U.S. Cl. CPC H04N 5/2254
USPC 348/373

(57) ABSTRACT

An image capturing module includes an image sensing unit and an actuator structure. The image sensing unit includes a carrier substrate and an image sensing chip disposed on the carrier substrate. The actuator structure includes a first actuator unit and a second actuator unit. The first actuator unit includes a first housing frame and a first movable assembly movably disposed inside the first housing frame and above the image sensing unit. The second actuator unit includes a second housing frame and a second movable assembly movably disposed inside the second housing frame and above the image sensing unit, and the second movable assembly includes a second movable casing movably disposed in the second housing frame, a microlens array substrate disposed in the second movable casing, and a nonconductive photosensitive film layer disposed on the microlens array substrate for increasing the light absorption capability.

### BACKGROUND OF THE INVENTION

1. Field of the Invention

The instant disclosure relates to an image capturing module and an actuator structure thereof, and more particularly to an image capturing module and an actuator structure thereof for increasing the image quality.

2. Description of Related Art

Recently, it becomes more and more popular for portable devices such as mobile phones or PDA to be equipped with an imaging module. Furthermore, since the market requires these portable devices to have more powerful functions and smaller sizes, it is necessary for the imaging module to generate high quality pictures and to be of small size accordingly. One improvement of picture quality is to increase the number of pixel. The pixel number of an imaging module has already increased from the VGA-level 30 pixels to 2, 5, 8, 13 or even 41 million pixels, which is now common in the market. Another improvement lies in the definition of the image. Thus, the imaging module of a portable device also develops from a fixed-focus mode to auto-focus mode or even optical zoom mode.

The auto-focus mode employs the principle of moving the lens in the imaging module suitably according to various distances of targets, whereby the optical image of the desired target can be focused correctly on an image sensor so as to generate a clear image. The common ways of activating the lens to move in the imaging module include activating by a stepping motor, piezoelectric motor and voice coil motor (VCM). However, when light source is not enough, the image quality provided by the imaging module would be decreased.

### SUMMARY OF THE INVENTION

One aspect of the instant disclosure relates to an image capturing module and an actuator structure of the image capturing module for increasing the image quality.

One of the embodiments of the instant disclosure provides an image capturing module, comprising: an image sensing unit and an actuator structure. The image sensing unit includes a carrier substrate and an image sensing chip disposed on the carrier substrate and electrically connected to the carrier substrate. The actuator structure includes a first actuator unit and a second actuator unit matched with the first actuator unit. In addition, the first actuator unit includes a first housing frame and a first movable assembly movably disposed inside the first housing frame and above the image sensing unit, and the first movable assembly includes a first movable casing movably disposed in the first housing frame and at least one optical lens group disposed in the first movable casing. Moreover, the second actuator unit includes a second housing frame and a second movable assembly movably disposed inside the second housing frame and above the image sensing unit, and the second movable assembly includes a second movable casing movably disposed in the second housing frame, a microlens array substrate disposed in the second movable casing, and a nonconductive photosensitive film layer disposed on the microlens array substrate for increasing the light absorption capability.

Another one of the embodiments of the instant disclosure provides an actuator structure applied to an image sensing unit, comprising: a first actuator unit and a second actuator unit. The first actuator unit includes a first housing frame and a first movable assembly movably disposed inside the first housing frame and above the image sensing unit, and the first movable assembly includes a first movable casing movably disposed in the first housing frame and at least one optical lens group disposed in the first movable casing. The second actuator unit is matched with the first actuator unit, wherein the second actuator unit includes a second housing frame and a second movable assembly movably disposed inside the second housing frame and above the image sensing unit, and the second movable assembly includes a second movable casing movably disposed in the second housing frame, a microlens array substrate disposed in the second movable casing, and a nonconductive photosensitive film layer disposed on the microlens array substrate for increasing the light absorption capability.

More precisely, the second housing frame is disposed on the carrier substrate to cover the image sensing chip, and the first housing frame is disposed on the second housing frame, wherein the microlens array substrate includes a light-transmitting substrate disposed in the second movable casing and a microlens array disposed on the bottom surface of the light-transmitting substrate and facing the image sensing unit, the microlens array is composed of a plurality of micro lenses separated from each other by a predetermined distance, and the nonconductive photosensitive film layer is disposed on the top surface of the light-transmitting substrate and facing the at least one optical lens group of the first movable assembly.

More precisely, the first housing frame is disposed on the carrier substrate to cover the image sensing chip, and the second housing frame is disposed on the first housing frame, wherein the microlens array substrate includes a light-transmitting substrate disposed in the second movable casing and a microlens array disposed on the bottom surface of the light-transmitting substrate and facing the at least one optical lens group, the microlens array is composed of a plurality of micro lenses separated from each other by a predetermined distance, and the nonconductive photosensitive film layer is disposed on the top surface of the light-transmitting substrate and opposite to the at least one optical lens group of the first movable assembly.

Therefore, because the microlens array substrate disposed in the second movable casing and the nonconductive photosensitive film layer disposed on the microlens array substrate for increasing the light absorption capability are used in the same image capturing module, the image quality of the instant disclosure can be increased.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a lateral, cross-sectional, schematic view of the image capturing module according to the first embodiment of the instant disclosure;

FIG. 2 shows a lateral, cross-sectional, schematic view of the image capturing module using a voice coil actuator according to the first embodiment of the instant disclosure;

FIG. 3 shows a lateral, cross-sectional, schematic view of the image capturing module according to the second embodiment of the instant disclosure;

FIG. 4 shows a lateral, cross-sectional, schematic view of the image capturing module according to the third embodiment of the instant disclosure; and

FIG. 5 shows a lateral, cross-sectional, schematic view of the image capturing module according to the fourth embodiment of the instant disclosure.

### DETAILED DESCRIPTION OF THE PREFERRED EMBODIMENTS

### First Embodiment

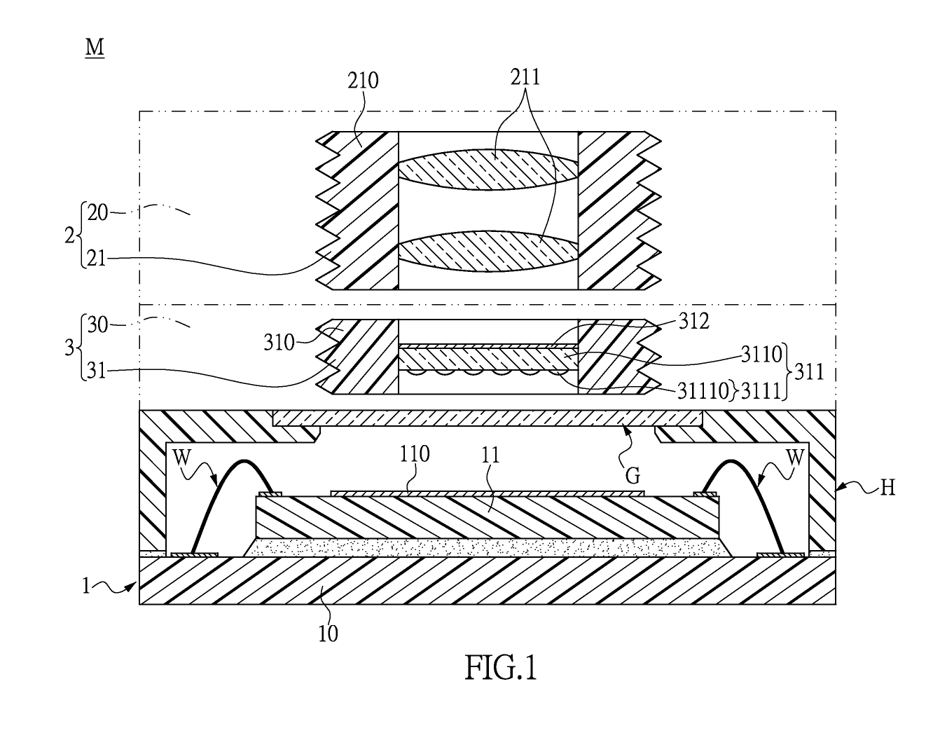

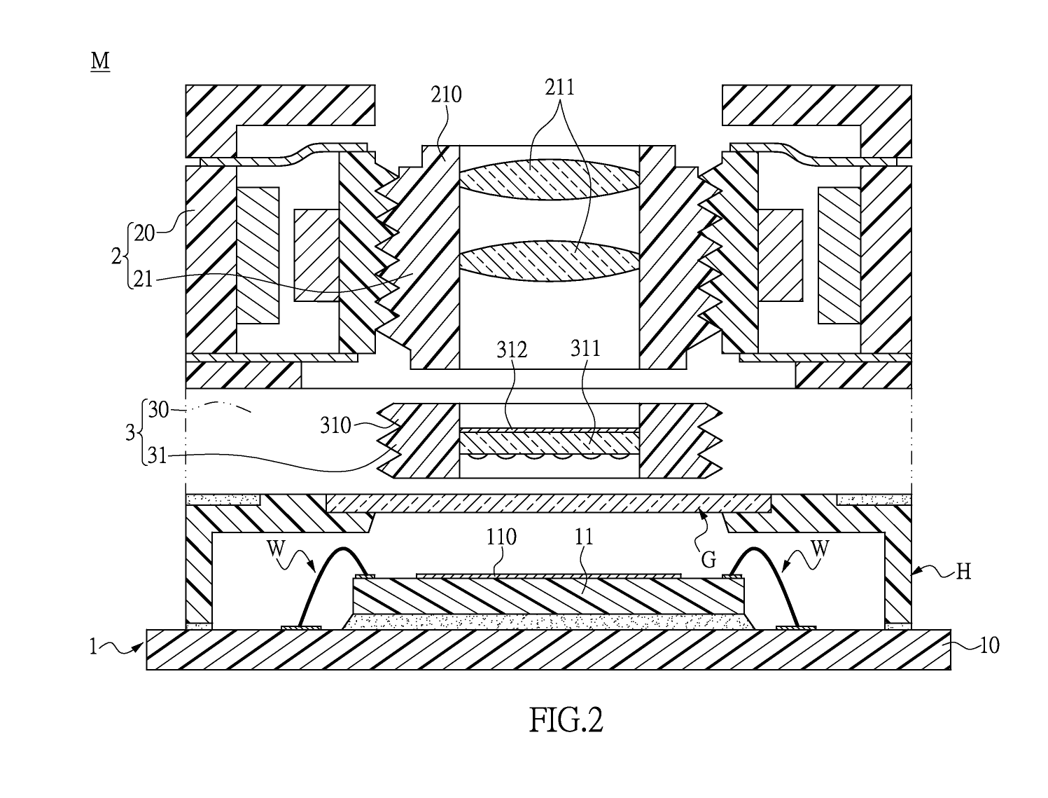

Referring to FIG. 1 and FIG. 2, where the first embodiment of the instant disclosure provides an image capturing module M, comprising: an image sensing unit 1 and an actuator structure.

First, the image sensing unit 1 includes a carrier substrate 10 and an image sensing chip 11 disposed on the carrier substrate 10 and electrically connected to the carrier substrate 10, and the image sensing chip 11 has an image sensing area 110 on the top side of the image sensing chip 11 for sensing or capturing images. For example, the image sensing chip 11 can be adhesively disposed on the carrier substrate 10 through any type of adhesive material (not labeled) such as UV adhesive glue, thermosetting glue or oven curing glue etc. In addition, the carrier substrate 10 may be a circuit substrate having a plurality of conductive pads (not labeled) disposed on the top surface of the circuit substrate, and the image sensing chip 11 has a plurality of conductive pads (not labeled) disposed on the top surface of the image sensing chip 11. Each conductive pad of the image sensing chip 11 can be electrically connected to the corresponding conducive pad of the carrier substrate 10 through the corresponding conducive wire W, thus the image sensing chip 11 can be electrically connected with the carrier substrate 10 through the conductive wires W.

Moreover, the actuator structure includes a first actuator unit 2 and a second actuator unit 3 matched with the first actuator unit 2. The first actuator unit 2 includes a first housing frame 20 and a first movable assembly 21 (such as a movable lens assembly) movably disposed inside the first housing frame 20 and above the image sensing unit 1, and the first movable assembly 21 includes a first movable casing 210 movably disposed in the first housing frame 20 and at least one optical lens group 211 disposed in the first movable casing 210. In addition, the second actuator unit 3 includes a second housing frame 30 and a second movable assembly 31 movably disposed inside the second housing frame 30 and above the image sensing unit 1, and the second movable assembly 31 includes a second movable casing 310 movably disposed in the second housing frame 30, a microlens array substrate 311 disposed in the second movable casing 310, and a nonconductive photosensitive film layer 312 disposed on the microlens array substrate 311 for increasing the light absorption capability.

More precisely, the second housing frame 30 is disposed on the carrier substrate 10 to cover the image sensing chip 11, and the first housing frame 20 is disposed on the second housing frame 30. In addition, the microlens array substrate 311 includes a light-transmitting substrate 3110 disposed in the second movable casing 310 and a microlens array 3111 disposed on the bottom surface of the light-transmitting substrate 3110 and facing the image sensing unit 1. The microlens array 3111 may be composed of a plurality of micro lenses 31110 separated from each other by a predetermined distance, and the nonconductive photosensitive film layer 312 is disposed on the top surface of the light-transmitting substrate 3110 and facing the optical lens group 211 of the first movable assembly 21.

Whereby, the nonconductive photosensitive film layer 312 can be used to efficiently guide light source to the micro lenses 31110 of the microlens array 3111 of the microlens array substrate 311, thus the image quality (such as the sharpness and the resolution) provided by the image sensing unit 1 can be increased by matching the microlens array substrate 311 and the nonconductive photosensitive film layer 312.

For example, the second housing frame 30 can be disposed on the carrier substrate 10 through any type of adhesive material (not labeled) such as UV adhesive glue, thermosetting glue or oven curing glue etc., and the first housing frame 20 can be disposed on the second housing frame 30 also through any type of adhesive material (not labeled) such as UV adhesive glue, thermosetting glue or oven curing glue etc. The optical lens group 211 and the microlens array 3111 of the microlens array substrate 311 can be respectively fixed inside the first movable casing 210 and the second movable casing 310, and the optical lens group 211 may be composed of a plurality of optical lenses, where this embodiment uses two optical lenses as the optical lens group 211 as shown in FIG. 1. In addition, the nonconductive photosensitive film layer 312 may be made of any type of nano-material for increasing the light absorption capability, and the nonconductive photosensitive film layer 312 can be disposed on the microlens array substrate 311 by laminating, coating, spraying or sputtering etc. Moreover, referring to FIG. 2, both the first actuator unit 2 and the second actuator unit 3 may be voice coil actuators, but the voice coil actuator used in the first embodiment is merely an example and is not meant to limit the instant disclosure.

It's worth mentioning that the image capturing module M further includes a holder frame H disposed on the carrier substrate 10 and a cover glass G supported by the holder frame H and disposed above the image sensing chip 11, for enhancing the image performance and the sensor surface cleanliness of the image sensing chip 11. For example, the cover glass G may be a borosilicate glass (a white/clear glass), an IR coated glass, a LSS glass, or a blue glass etc., but it is merely an example and not meant to limit the instant disclosure.

### Second Embodiment

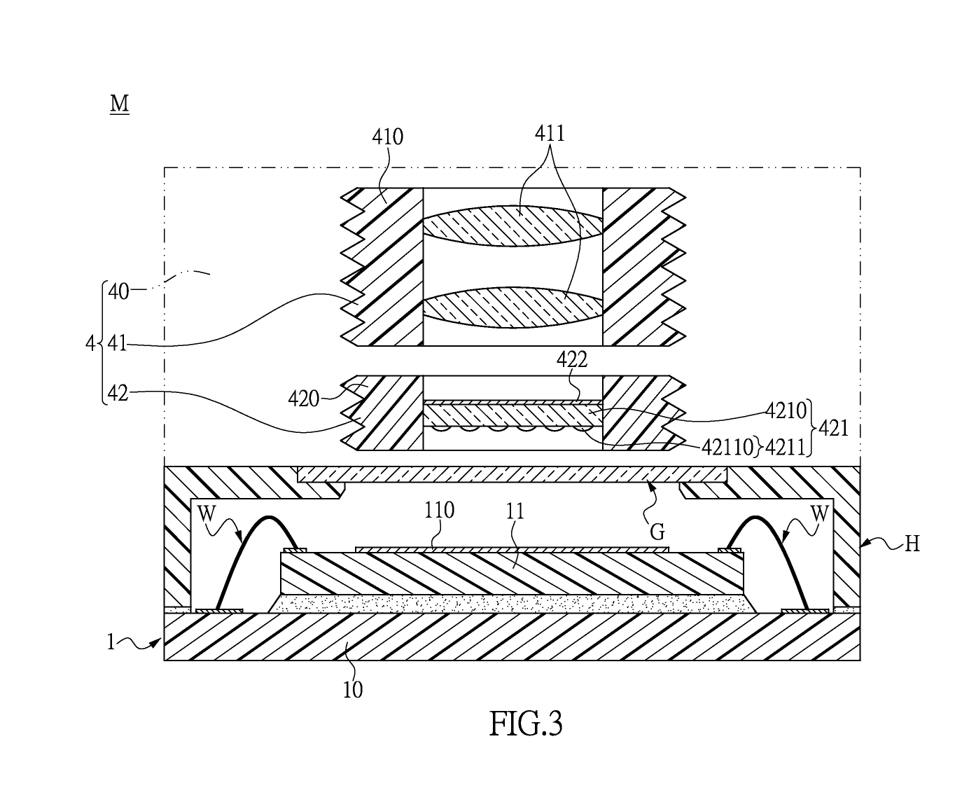

Referring to FIG. 3, where the second embodiment of the instant disclosure provides an image capturing module M, comprising: an image sensing unit 1 and an actuator structure 4. Comparing FIG. 3 with FIG. 1, the difference between the second embodiment and the first embodiment is as follows: the first housing frame 20 and the second housing frame 30 of the first embodiment can be integrally combined with each other to form a single housing frame 40 applied to the second embodiment, and both the first movable assembly 41 and the second movable assembly 42 of the actuator structure 4 can be movably disposed in the single housing frame 40. Furthermore, the first movable assembly 41 includes a first movable casing 410 movably disposed in the single housing frame 40 and at least one optical lens group 411 disposed in the first movable casing 410. In addition, the second movable assembly 42 includes a second movable casing 420 movably disposed in the single housing frame 40, a microlens array substrate 421 disposed in the second movable casing 420, and a nonconductive photosensitive film layer 422 disposed on the microlens array substrate 421 for increasing the light absorption capability.

More precisely, the single housing frame 40 is disposed on the carrier substrate 10 to cover the image sensing chip 11, and the microlens array substrate 421 includes a light-transmitting substrate 4210 disposed in the second movable casing 420 and a microlens array 4211 disposed on the bottom surface of the light-transmitting substrate 4210 and facing the image sensing unit 1. In addition, the microlens array 4211 may be composed of a plurality of micro lenses 42110 separated from each other by a predetermined distance, and the nonconductive photosensitive film layer 422 is disposed on the top surface of the light-transmitting substrate 4210 and facing the optical lens group 411 of the first movable assembly 41. In other words, the first housing frame 20 and the second housing frame 30 can be used as a two piece housing frame (shown as the first embodiment in FIG. 1), or both the first housing frame 20 and the second housing frame 30 integrally combined with each other can be used as a single piece housing frame (shown as the second embodiment in FIG. 3), according to difference requirements.

### Third Embodiment

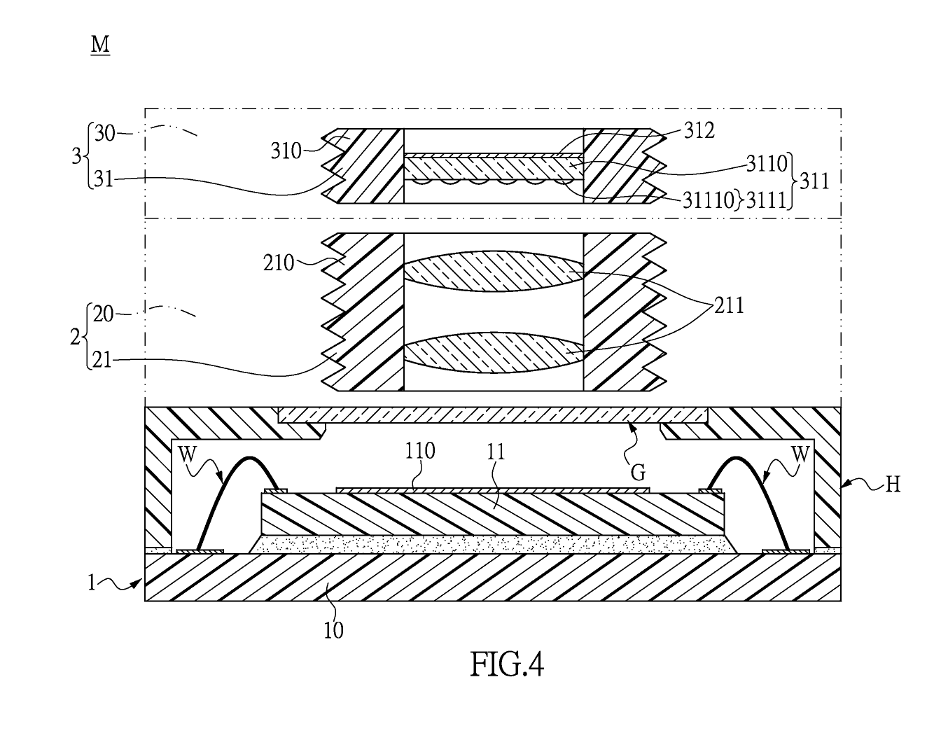

Referring to FIG. 4, where the third embodiment of the instant disclosure provides an image capturing module M, comprising: an image sensing unit 1 and an actuator structure. Comparing FIG. 4 with FIG. 1, the difference between the third embodiment and the first embodiment is as follows: in the third embodiment, the first housing frame 20 is disposed on the carrier substrate 10 to cover the image sensing chip 11, and the second housing frame 30 is disposed on the first housing frame 20. In addition, the microlens array substrate 311 includes a light-transmitting substrate 3110 disposed in the second movable casing 310 and a microlens array 3111 disposed on the bottom surface of the light-transmitting substrate 3110 and facing the optical lens group 211, and the nonconductive photosensitive film layer 312 is disposed on the top surface of the light-transmitting substrate 311 and opposite to the optical lens group 211 of the first movable assembly 21. In other words, the first housing frame 20 and the second housing frame 30 can be sequentially stacked on top of one another and disposed on the image sensing unit 1 (shown as the first embodiment in FIG. 1), or the second housing frame 30 and the first housing frame 20 can be sequentially stacked on top of one another and disposed on the image sensing unit 1 (shown as the third embodiment in FIG. 4), according to different requirements.

### Fourth Embodiment

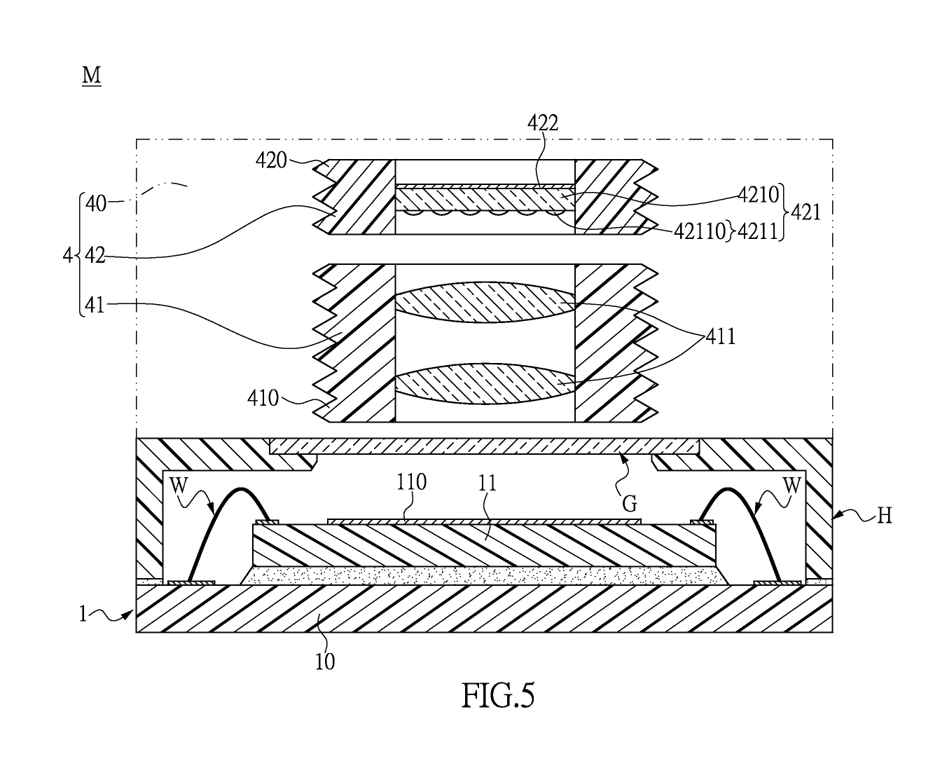

Referring to FIG. 5, where the fourth embodiment of the instant disclosure provides an image capturing module M, comprising: an image sensing unit 1 and an actuator structure 4. Comparing FIG. 5 with FIG. 4, the difference between the fourth embodiment and the third embodiment is as follows: the first housing frame 20 and the second housing frame 30 of the third embodiment can be integrally combined with each other to form a single housing frame 40 applied to the fourth embodiment, and both the first movable assembly 41 and the second movable assembly 42 of the actuator structure 4 can be movably disposed in the single housing frame 40. Furthermore, the first movable assembly 41 includes a first movable casing 410 movably disposed in the single housing frame 40 and at least one optical lens group 411 disposed in the first movable casing 410. In addition, the second movable assembly 42 includes a second movable casing 420 movably disposed in the single housing frame 40, a microlens array substrate 421 disposed in the second movable casing 420, and a nonconductive photosensitive film layer 422 disposed on the microlens array substrate 421 for increasing the light absorption capability.

More precisely, the single housing frame 40 is disposed on the carrier substrate 10 to cover the image sensing chip 11, and the microlens array substrate 421 includes a light-transmitting substrate 4210 disposed in the second movable casing 420 and a microlens array 4211 disposed on the bottom surface of the light-transmitting substrate 4210 and facing the optical lens group 411. In addition, the microlens array 4211 may be composed of a plurality of micro lenses 42110 separated from each other by a predetermined distance, and the nonconductive photosensitive film layer 422 is disposed on the top surface of the light-transmitting substrate 4210 and opposite to the optical lens group 411 of the first movable assembly 41. In other words, the first housing frame 20 and the second housing frame 30 can be used as a two piece housing frame (shown as the third embodiment in FIG. 4), or both the first housing frame 20 and the second housing frame 30 integrally combined with each other can be used as a single piece housing frame (shown as the fourth embodiment in FIG. 5), according to difference requirements.

In conclusion, because the microlens array substrate (311, 421) disposed in the second movable casing (310, 420) and the nonconductive photosensitive film layer (312, 422) disposed on the microlens array substrate (311, 421) for increasing the light absorption capability are used in the same image capturing module M, the image quality of the instant disclosure can be increased. In other words, the nonconductive photosensitive film layer (312, 422) can be used to efficiently guide light source to the micro lenses (31110, 42110) of the microlens array (3111, 4211) of the microlens array substrate (311, 421), thus the image quality (such as the sharpness and the resolution) provided by the image sensing unit 1 can be increased by matching the microlens array substrate (311, 421) and the nonconductive photosensitive film layer (312, 422).

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. An image capturing module, comprising:
an image sensing unit including a carrier substrate and an image sensing chip disposed on the carrier substrate and electrically connected to the carrier substrate; and
an actuator structure including a first actuator unit and a second actuator unit matched with the first actuator unit;
wherein the first actuator unit includes a first housing frame and a first movable assembly movably disposed inside the first housing frame and above the image sensing unit, and the first movable assembly includes a first movable casing movably disposed in the first housing frame and at least one optical lens group disposed in the first movable casing;
wherein the second actuator unit includes a second housing frame and a second movable assembly movably disposed inside the second housing frame and above the image sensing unit, and the second movable assembly includes a second movable casing movably disposed in the second housing frame, a microlens array substrate disposed in the second movable casing, and a nonconductive photosensitive film layer disposed on the microlens array substrate for increasing the light absorption capability.

2. The image capturing module of claim 1, wherein the second housing frame is disposed on the carrier substrate to cover the image sensing chip, and the first housing frame is disposed on the second housing frame, wherein the microlens array substrate includes a light-transmitting substrate disposed in the second movable casing and a microlens array disposed on the bottom surface of the light-transmitting substrate and facing the image sensing unit, the microlens array is composed of a plurality of micro lenses separated from each other by a predetermined distance, and the nonconductive photosensitive film layer is disposed on the top surface of the light-transmitting substrate and facing the at least one optical lens group of the first movable assembly.

3. The image capturing module of claim 1, wherein the first housing frame is disposed on the carrier substrate to cover the image sensing chip, and the second housing frame is disposed on the first housing frame, wherein the microlens array substrate includes a light-transmitting substrate disposed in the second movable casing and a microlens array disposed on the bottom surface of the light-transmitting substrate and facing the at least one optical lens group, the microlens array is composed of a plurality of micro lenses separated from each other by a predetermined distance, and the nonconductive photosensitive film layer is disposed on the top surface of the light-transmitting substrate and opposite to the at least one optical lens group of the first movable assembly.

4. The image capturing module of claim 1, wherein the first housing frame and the second housing frame are integrally combined with each other to form a single housing frame, and both the first movable assembly and the second movable assembly are movably disposed in the single housing frame.

5. The image capturing module of claim 4, wherein the single housing frame is disposed on the carrier substrate to cover the image sensing chip, and the microlens array substrate includes a light-transmitting substrate disposed in the single housing frame and a microlens array disposed on the bottom surface of the light-transmitting substrate and facing the image sensing unit, the microlens array is composed of a plurality of micro lenses separated from each other by a predetermined distance, and the nonconductive photosensitive film layer is disposed on the top surface of the light-transmitting substrate and facing the at least one optical lens group of the first movable assembly.

6. The image capturing module of claim 4, wherein the single housing frame is disposed on the carrier substrate to cover the image sensing chip, and the microlens array substrate includes a light-transmitting substrate disposed in the single housing frame and a microlens array disposed on the bottom surface of the light-transmitting substrate and facing the at least one optical lens group, the microlens array is composed of a plurality of micro lenses separated from each other by a predetermined distance, and the nonconductive photosensitive film layer is disposed on the top surface of the light-transmitting substrate and opposite to the at least one optical lens group of the first movable assembly.

7. An actuator structure applied to an image sensing unit, comprising:
a first actuator unit, wherein the first actuator unit includes a first housing frame and a first movable assembly movably disposed inside the first housing frame and above the image sensing unit, and the first movable assembly includes a first movable casing movably disposed in the first housing frame and at least one optical lens group disposed in the first movable casing; and
a second actuator unit matched with the first actuator unit, wherein the second actuator unit includes a second housing frame and a second movable assembly movably disposed inside the second housing frame and above the image sensing unit, and the second movable assembly includes a second movable casing movably disposed in the second housing frame, a microlens array substrate disposed in the second movable casing, and a nonconductive photosensitive film layer disposed on the microlens array substrate for increasing the light absorption capability.

8. The actuator structure of claim 7, wherein the second housing frame is disposed on a carrier substrate of the image sensing unit to cover an image sensing chip of the image sensing unit, and the first housing frame is disposed on the second housing frame, wherein the microlens array substrate includes a light-transmitting substrate disposed in the second movable casing and a microlens array disposed on the bottom surface of the light-transmitting substrate and facing the image sensing unit, the microlens array is composed of a plurality of micro lenses separated from each other by a predetermined distance, and the nonconductive photosensitive film layer is disposed on the top surface of the light-transmitting substrate and facing the at least one optical lens group of the first movable assembly.

9. The actuator structure of claim 7, wherein the first housing frame is disposed on a carrier substrate of the image sensing unit to cover an image sensing chip of the image sensing unit, and the second housing frame is disposed on the first housing frame, wherein the microlens array substrate includes a light-transmitting substrate disposed in the second movable casing and a microlens array disposed on the bottom surface of the light-transmitting substrate and facing the at least one optical lens group, the microlens array is composed of a plurality of micro lenses separated from each other by a predetermined distance, and the nonconductive photosensitive film layer is disposed on the top surface of the light-transmitting substrate and opposite to the at least one optical lens group of the first movable assembly.

10. The actuator structure of claim 7, wherein the first housing frame and the second housing frame are integrally combined with each other to form a single housing frame, and both the first movable assembly and the second movable assembly are movably disposed in the single housing frame.

11. The actuator structure of claim 10, wherein the single housing frame is disposed on a carrier substrate of the image sensing unit to cover an image sensing chip of the image sensing unit, and the microlens array substrate includes a light-transmitting substrate disposed in the single housing frame and a microlens array disposed on the bottom surface of the light-transmitting substrate and facing the image sensing unit, the microlens array is composed of a plurality of micro lenses separated from each other by a predetermined distance, and the nonconductive photosensitive film layer is disposed on the top surface of the light-transmitting substrate and facing the at least one optical lens group of the first movable assembly.

12. The actuator structure of claim 10, wherein the single housing frame is disposed on a carrier substrate of the image sensing unit to cover an image sensing chip of the image sensing unit, and the microlens array substrate includes a light-transmitting substrate disposed in the single housing frame and a microlens array disposed on the bottom surface of the light-transmitting substrate and facing the at least one optical lens group, the microlens array is composed of a plurality of micro lenses separated from each other by a predetermined distance, and the nonconductive photosensitive film layer is disposed on the top surface of the light-transmitting substrate and opposite to the at least one optical lens group of the first movable assembly.
